(19) United States
(12) Patent Application Publication
(10) Pub. No.: US 2025/0005736 A1
(43) Pub. Date: Jan. 2, 2025

(54) IMAGE DETECTION DEVICE AND IMAGE DETECTION METHOD FOR OBJECTS

(71) Applicant: KINPO ELECTRONICS, INC., New Taipei City (TW)

(72) Inventor: Kuo-Sen TSENG, NEW TAIPEI CITY (TW)

(21) Appl. No.: 18/242,749

(22) Filed: Sep. 6, 2023

(30) Foreign Application Priority Data
Jun. 30, 2023 (CN) 202310794707.3

(51) Int. Cl. G06T 7/00; G06T 7/13; G06T 7/136; G06T 7/73

(52) U.S. Cl. CPC G06T 7/001; G06T 7/13; G06T 7/136; G06T 7/73

(57) ABSTRACT

An image detection device includes an image capturing module, a storage medium, and a processor. The processor is connected to the image capturing module and the storage medium and configured to obtain a plurality of sample object images of an image of object to be inspected; store the plurality of sample object images to a sample image array, where the sample image array and a standard image file array include same array index and the standard image file array includes a plurality of standard object images; respectively compare the plurality of sample object images of the sample image array and the plurality of standard object images of the standard image file array based on the array index to compute an inference score of each of the plurality of sample object images; and estimate an object quality according to the inference score of the plurality of sample object images.

### BACKGROUND OF THE DISCLOSURE

### Technical Field

The disclosure generally relates to a detection device and a detection method, and more particularly, to a detection device and a detection method for effectively comparing images of objects to be inspected and quickly determining the quality condition of physical objects.

### Description of Related Art

In the field of detecting object's quality, the image processing techniques are often applied to analyze the image features of objects in images. Because the image features of the objects are related to physical objects, analyzing the image features can be used to determine the quality of the physical objects.

In the related art, the image detection device requires analyzing the image features of the entire object image to estimate the quality of the physical object, which consumes significant computation resources. In environments where a large number of physical objects need to be inspected, the current image detection techniques are unable to provide satisfying performance.

As the situation described above, the problem of consuming computation resources in image detection technology remains to be resolved.

### SUMMARY OF THE DISCLOSURE

One of the exemplary embodiments of the present disclosure is to provide an image detection device. The image detection device includes an image capturing module, a storage medium, and a processor. The image capturing module is configured to obtain an image of object to be inspected from an object to be inspected. The storage medium is configured to store a standard image file array, where the standard image file array includes a plurality of standard object images. The processor is connected to the image capturing module and the storage medium and configured to obtain a plurality of sample object images from the image of object to be inspected; store the plurality of sample object images to a sample image array, wherein the sample image array and the standard image file array comprise same array index; respectively compare the plurality of sample object images of the sample image array and the plurality of standard object images of the standard image file array based on the array index to compute an inference score of each of the plurality of sample object images; and estimate a quality of the object to be inspected according to the inference score of the plurality of sample object images.

One of the exemplary embodiments of the present disclosure is to provide an image detection method for an object to be inspected, including obtaining an image of object to be inspected from an object to be inspected; obtaining a plurality of sample object images from the image of object to be inspected; storing the plurality of sample object images to a sample image array, wherein the sample image array and a standard image file array comprise same array index and the standard image file array includes a plurality of standard object images; respectively comparing the plurality of sample object images of the sample image array with the plurality of standard object images of the standard image file array to compute an inference score of each of the plurality of sample object images; and estimating a quality of the object to be inspected according to the inference score of the plurality of sample object images.

The disclosure reduces the problem of misjudgment when comparing with the image features comparison of the image blocks and enhances the efficiency of image detection.

It is understood that both the foregoing general description and the following detailed description are by examples, and are intended to provide further explanation of the disclosure as claimed.

### BRIEF DESCRIPTION OF THE DRAWINGS

FIG. 1 is a schematic diagram illustrating an image of object to be inspected of a physical object captured by a camera according to one embodiment of the present disclosure.

FIG. 2 is a block diagram illustrating an image detection device according to one embodiment of the present disclosure.

FIG. 3 is a flowchart illustrating an image detection method according to one embodiment of the present disclosure.

FIG. 4 is a schematic diagram illustrating the image of object to be inspected according to one embodiment of the present disclosure.

FIG. 5 illustrates an example binary image of the image of object to be inspected according to one embodiment of the present disclosure.

FIG. 6 illustrates an example tilt angle of the image of object to be inspected according to one embodiment of the present disclosure.

FIG. 7 is a schematic diagram illustrating minimum bounding rectangles corresponding to the first object contours of the image of object to be inspected according to one embodiment of the present disclosure.

FIG. 8 is a schematic diagram illustrating the sample image array according to one embodiment of the present disclosure.

FIG. 9 is a flowchart of creating the standard image file array according to one embodiment of the present disclosure.

FIG. 10 is a schematic diagram illustrating the standard image according to one embodiment of the present disclosure.

FIG. 11 is a schematic diagram illustrating the binary image of the standard image according to one embodiment of the present disclosure.

FIG. 12 illustrates an example standard image file array according to one embodiment of the present disclosure.

### DETAILED DESCRIPTION

The technical terms “first”, “second”, and the similar terms are used to describe elements for distinguishing the same or similar elements or operations and are not intended to limit the technical elements and the order of the operations in the present disclosure. Furthermore, the element symbols/alphabets can be used repeatedly in each embodiment of the present disclosure. The same and similar technical terms can be represented by the same or similar symbols/alphabets in each embodiment. The repeated symbols/alphabets are provided for simplicity and clarity and they should not be interpreted to limit the relation of the technical terms among the embodiments.

Reference will now be made in detail to the present embodiments of the disclosure, examples of which are illustrated in the accompanying drawings. Wherever possible, the same reference numbers are used in the drawings and the description to refer to the same or like parts.

For the sake of understanding the disclosure, the technical terms “object to be inspected” or “physical object” take the electronic calculator having hardware components as an example. Similarly, the image of the “object to be inspected” takes the image of the electronic calculator as an example. Nevertheless, the “object to be inspected” or “physical object” implemented in the disclosure is not limited to the electronic calculator. Any object applied for image detection belongs to the scope of the disclosure.

For detecting whether the buttons of the electronic calculator have defects, an image detection device transforms the image of the electronic calculator into a binary image and then detects multiple contours in the binary image that may be the contours of the buttons. In the situation that the electronic calculator inclines, because the operation of segmenting image blocks is constrained by a rectangle box and the rectangle box cannot be rotated freely, the image detection device may not retrieve the image blocks of the entire buttons by using the operation of segmentations without rotating the rectangle box.

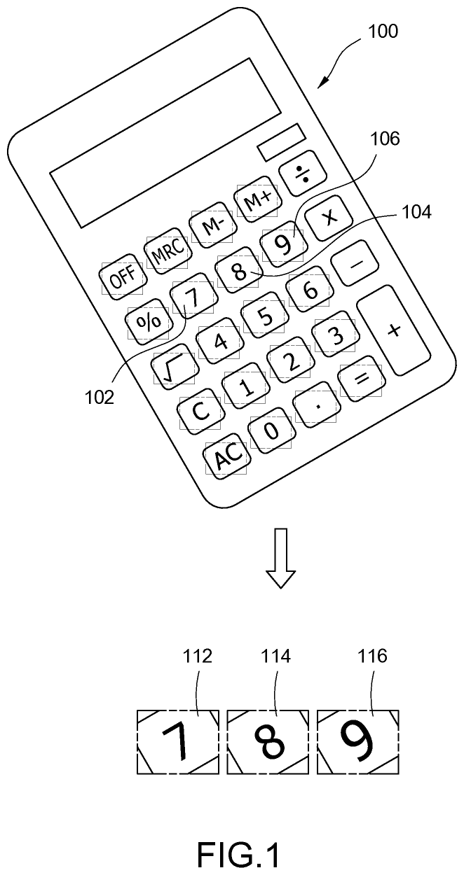

Reference is made to FIG. 1. FIG. 1 is a schematic diagram illustrating an image of object to be inspected of a physical object captured by a camera according to one embodiment of the present disclosure. The content of the image of object to be inspected 100 is the electronic calculator, and the electronic device inclines leftward in comparing with a horizontal base line (not shown). The electronic calculator has multiple buttons, such as the buttons ‘OFF’, ‘7’, ‘8’, and ‘9’, etc. Each button of the electronic calculator has a button border, and the image detection device obtains the position of each button by detecting the button border.

After detecting the positions of all buttons, the image detection device obtains the image block(s) selected by the rectangle(s). Taking three image blocks as an example, the rectangles are the dotted-line frames 102, 104, and 106 shown in FIG. 1. The image detection device segments the image of object to be inspected 100 based on the coordinate positions of the dotted-line frames 102, 104, and 106 to obtain the image blocks 112, 114, and 116.

As described above, because the electronic calculator inclines, the image detection device may not retrieve the entire button border from the image blocks 112, 114, and 116. For example, the image block 112 represents the button ‘7’ in FIG. 1, and the border of the button ‘7’ is broken in the image block 112. The other buttons also exist the same problem. Once the button border of the image block segmented by the image detection device is broken, errors may occur in the process of determining the content of the image blocks due to the broken outlines, skewed fonts, or other similar factors. The errors lead to incorrect comparisons and result in misjudgments of the quality of the object being inspected.

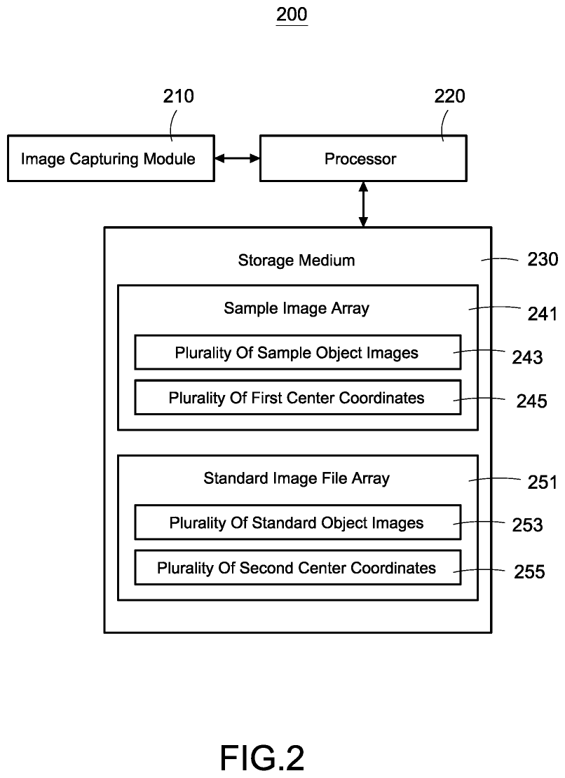

Reference is made to FIG. 2. FIG. 2 is a block diagram illustrating an image detection device according to one embodiment of the present disclosure. The image detection device 200 includes an image capturing module 210, a processor 220, and a storage medium 230. The processor 220 is connected with the image capturing module 210 and the storage medium 230.

In one embodiment, the image capturing device 210 is configured to capture an image of object to be inspected from an object to be inspected placed on a platform (not shown in Figures).

In one embodiment, the storage medium 230 is configured to store a sample image array 241 and a standard image file array 251. The sample image array 241 includes a plurality of sample object images 243 and a plurality of first center coordinates 245. The standard image file array 251 includes a plurality of standard object images 253 and a plurality of second center coordinates 255. The operations of generating the sample image array 241 and the standard image file array 251 are described below.

The image capturing module 210 may be a module including image sensors and image processing circuits.

The processor 220 may be but not limited to a Digital Signal Processor (DSP), an Application Specific Integrated Circuit (ASIC), a Central Processing Unit (CPU), a System on Chip (SoC), a Field Programmable Gate Array (FPGA), a Network Processor IC, or the combination of the components above.

The storage medium 230 may be but not limited to a Random Access Memory (RAM), a nonvolatile memory (such as flash memory), a Read-Only Memory (ROM), a Hard Disk Drive (HDD), a Solid-State Drive (SSD), an Optical Storage, or the combination of the components above.

In one embodiment, the image detection device 200 is configured to obtain the plurality of sample object images 243 from the image of object to be inspected and store the plurality of sample object images 243 to the sample image array 241. Because the sample image array 241 and the standard image file array 251 have the same array index, the image detection device 200 respectively compares the plurality of sample object images 243 of the sample image array 241 and the plurality of standard object image 253 of the standard image file array 251 based on the array index to compute an inference score of each sample object images. After analyzing the inference scores of all the sample object images 243, the image detection device 200 generates an analysis result of the quality of the object to be inspected. Detailed steps of the image detection method are described below.

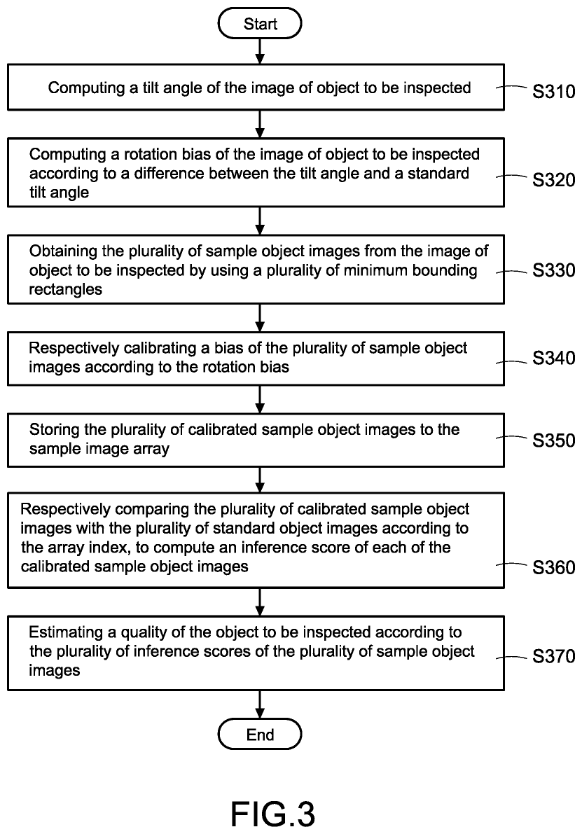

Reference is made to FIG. 3. FIG. 3 is a flowchart illustrating an image detection method according to one embodiment of the present disclosure. The image detection method may be performed by the image detection device 200 in FIG. 2.

In step S310, the processor 220 computes a tilt angle of the image of object to be inspected.

In step S320, the processor 220 computes a rotation bias of the image of object to be inspected according to a difference between the tilt angle and a standard tilt angle.

In step S330, the processor 220 obtains the plurality of sample object images from the image of object to be inspected by using a plurality of minimum bounding rectangles.

In step S340, the processor 220 respectively calibrates a bias of the plurality of sample object images according to the rotation bias.

In step S350, the processor 220 stores the plurality of calibrated sample object images to the sample image array.

In step S360, the processor 220 respectively compares the plurality of calibrated sample object images with the plurality of standard object images according to the array index, to compute an inference score of each of the calibrated sample object images.

In step S370, the processor 220 estimates a quality of the object to be inspected according to the plurality of inference scores of the plurality of sample object images.

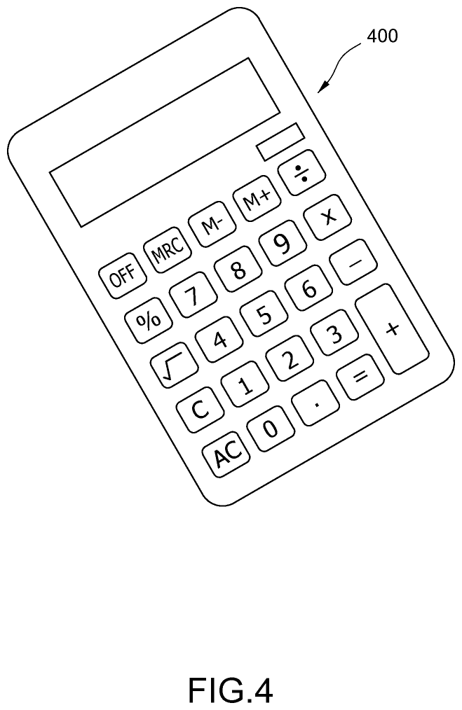

In one embodiment, in step S310 the image detection device 200 first captures an image of the object to be inspected by the image capturing module 110 to generate the image of object to be inspected. Reference is made to FIG. 4. FIG. 4 is a schematic diagram illustrating the image of object to be inspected according to one embodiment of the present disclosure. The content of the image of object to be inspected 400 shows the electronic calculator having multiple buttons, and each button has a button border. In the embodiment, the electronic calculator inclines leftward (i.e., a filming angle related to the image capturing module 210) comparing with a horizontal basis in the image of object to be inspected 400.

Please refer back to FIG. 3. In the embodiment, in step S310 the processor 220 computes the tilt angle of the image of object to be inspected 400. The description below shows how the processor 220 computes the tilt angle of the image of object to be inspected 400.

In one embodiment, the processor 220 performs a binary thresholding computation to the image of object to be inspected 400 to obtain the first binary image.

In one embodiment, the binary thresholding computation performed by the processor 320 may be the binary thresholding computation (THRESH_BINARY), the inverse-binary thresholding computation (THRESH_BINARY_INV), the truncate thresholding computation (THRESH_TRUNC), the threshold to zero computation (THRESH_TOZERO), or the inverted threshold to zero computation (THRESH_TOZERO_INV) of OpenCV (Open Source Computer Vision Library). The processor 320 processes the image of object to be inspected 400 by the binary thresholding computation to generate a binary image (or called “monochrome image”).

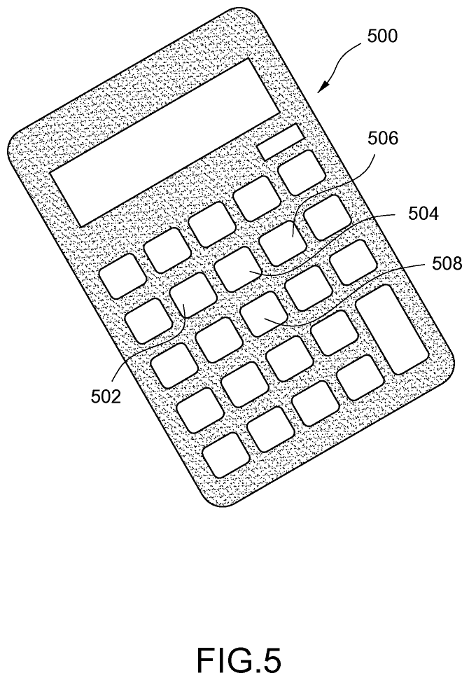

Reference is made to FIG. 5. FIG. 5 illustrates an example binary image of the image of object to be inspected according to one embodiment of the present disclosure.

The first binary image 500 is a monochrome image. Because the first binary image 500 is generated by the image processing, image features of the first binary image 500 are highly contrasting and the processor 220 may easily retrieve the contours of the buttons (e.g., first object contours 502, 504, 506, and 508 of the white image blocks) from the first binary image 500 based on the image features of the first binary image 500.

In one embodiment, the processor 220 detects the first object contour 502 of the first binary image 500 and computes a first center coordinate of the first object contour 502. Similarly, the processor 220 detects the first object contours 504, 506, and 508 of the first binary image 500 and respectively computes the first center coordinates of the first object contours 504, 506, and 508. In other words, the processor 220 computes the center coordinate of each first object contour retrieved from the first binary image 500.

It should be noted that the processor 220 obtains the center coordinates of the first object contours 502, 504, 506, and 508 by using any existing tools, and the operations of retrieving the center coordinates are not limited herein.

In one embodiment, the processor 220 computes a tilt angle of the image of object to be inspected with respect to the horizontal basis according to the origin coordinate and at least two coordinates of the plurality of first center coordinates. For example, the difference value between the y-axis values of the two coordinates is minimal among the coordinates, that is, the two coordinates are located on the same straight line. As shown in FIG. 5, the difference value between the y-axis values of the center coordinate of the first object contour 502 and that of the first object contour 504 is less than the difference value between the y-axis value of the center coordinate of the first object contour 502 and that of the first object contour 508. Accordingly, the processor 220 uses the center coordinates of the first object contour 502 and the center coordinates of the first object contour 504 to compute a line that represents the tilt level of the image of object to be inspected 400 when computing the tilt angle.

In one embodiment, the origin coordinate is the image point at the top-left corner of the image of object to be inspected 400 and is used as a computing basis of the tilt level of the image of object to be inspected 400.

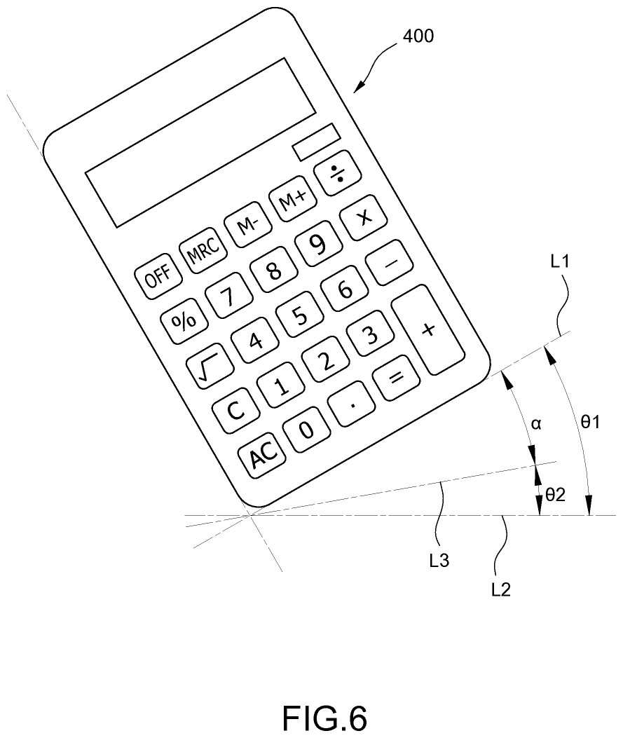

Reference is made to FIG. 6. FIG. 6 illustrates an example tilt angle of the image of object to be inspected according to one embodiment of the present disclosure.

Following the embodiment mentioned above, the processor 220 computes the line that represents the tilt level of the image of object to be inspected 400 where the line is parallel to the line L1. For the sake of reading, the line L1 represents the tilt level of the image of object to be inspected 400.

As shown in FIG. 6, the line L2 is the horizontal basis. The processor 220 computes the tilt angle θ1 of the image of object to be inspected 400 according to the line L1 and the line L2. The processor 220 further computes the difference value between the tilt angle θ1 and the standard tilt angle θ2 to obtain the angle α. The angle α is the rotation bias of the image of object to be inspected 400 with respect to the standard tilt angle θ2. It should be noted that the standard tilt angle θ2 (i.e., the angle between the line L2 and the line L3) is the pre-setting angle set by the processor 220 based on the standard image and will be described below.

Please refer back to FIG. 3. In the embodiment, in step S330 the processor 220 generates multiple minimum bounding rectangles each respectively enclosing each first object contour of the first binary image 500 (FIG. 5). Each minimum bounding rectangle is generated to segment the image block corresponding to one object contour of the image of object to be inspected 400 to obtain the sample object image 243.

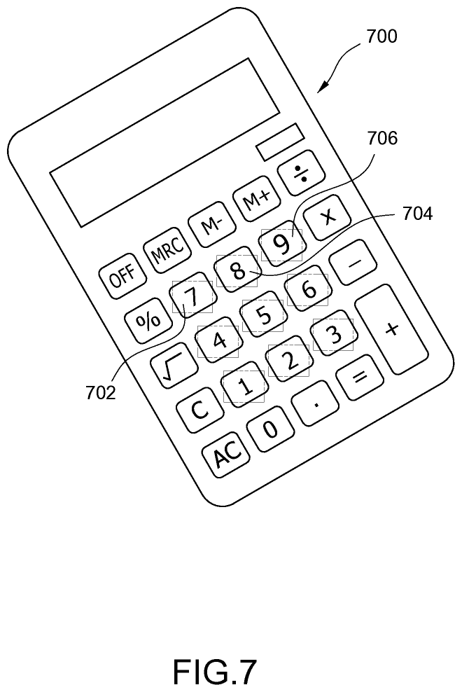

Reference is made to FIG. 7. FIG. 7 is a schematic diagram illustrating minimum bounding rectangles corresponding to the first object contours of the image of object to be inspected according to one embodiment of the present disclosure.

In one embodiment, the minimum bounding rectangle 702 encloses the first object contour 502 (FIG. 5); the minimum bounding rectangle 704 encloses the first object contour 504 (FIG. 5); and the minimum bounding rectangle 706 encloses the first object contour 506 (FIG. 5).

In one embodiment, the processor 220 uses the minimum bounding rectangle 702 to obtain one of the sample object images 243 (such as the image block of the button ‘7’) of the image of object to be inspected 400. Similarly, the processor 220 uses the minimum bounding rectangle 704 to obtain one of the sample object images 243 (such as the image block of the button ‘8’) of the image of object to be inspected 400; the processor 220 uses the minimum bounding rectangle 706 to obtain one of the sample object images 243 (such as the image block of the button ‘9’) of image of object to be inspected 400.

It should be noted that when part of the pixel values of the button borders of the image of object to be inspected 400 are close to the binary threshold of the binary image processing, in some situations, the feature of the button borders becomes the background pixel of the binary image 500 (e.g., the button border of the binary image 500 should be transformed into white pixels but it is transformed into black pixels instead) after the image pixels are processed by the binary image processing. As a result, the minimum bounding rectangle obtained by the binary image processing encloses one of the first object contours of the binary image 500; however, the minimum bounding rectangle may not enclose the button border of the image of object to be inspected 400.

Please refer back to FIG. 3. In the embodiment, in step S340 the processor 220 uses the rotation bias, i.e., the angel α shown in FIG. 6, to respectively calibrate the angle bias of the plurality of the sample object images 243 being obtained.

Please refer to FIG. 6 again, the line L2 is the horizontal basis, and the tilt angle θ1 of the image of object to be inspected 400 is greater than the standard tilt angle θ2 in counterclockwise by the angel α. The processor 220 takes the center coordinate retrieved above as the rotation basis and rotates the sample object images 243 in a clockwise direction by the angle α, so the sample object images 243 are calibrated and the rotation bias of each of the sample object images 243 is reduced or eliminated, such that the tilt angle of each sample object image 243 after being calibrated is consistent with the standard tilt angle of the sample object image. It should be noted that each sample object image 243 has a corresponding center coordinate (such as the first center coordinate 245 shown in FIG. 2), and the processor 220 performs the rotation calibration to each sample object image 243 based on each sample object image's center coordinate.

Please refer back to FIG. 3. In the embodiment, in step S350 the processor 220 stores the calibrated sample object images and the retrieved first center coordinates 245 to the sample image array 241.

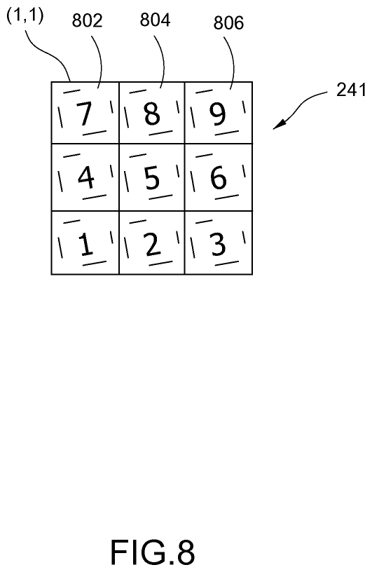

Reference is made to FIG. 8. FIG. 8 is a schematic diagram illustrating the sample image array according to one embodiment of the present disclosure.

The sample image array 241 includes multiple calibrated sample object images, which at least includes the calibrated sample object images 802, 804, and 806 as shown in FIG. 8. Comparing with the image blocks enclosed by the minimum bounding rectangles in FIG. 7, the object content of the calibrated sample object images 802, 804, and 806 is less askew. For example, the number ‘7’ of the calibrated sample object image 802 is more regular (i.e., the tilt angle is calibrated to be the counterclockwise bias angle θ2 with respect to the horizontal basis) than the number ‘7’ of the image block enclosed by the minimum bounding rectangle 702 in FIG. 7.

It should be noted that each entry of the sample image array 241 stores the center coordinate (not shown in FIG. 8) retrieved from the binary image 500 and the sample object image retrieved from the image of object to be inspected 400, where the center coordinate may be used as the coordinate representing the sample object image.

Please refer back to FIG. 3. In the embodiment, in step S360 the processor 220 respectively reads each entry of the sample image array 241 and the standard image file array 251. The plurality of standard object images 253 in the standard image file array 251 are generated by analyzing the standard image in advance and regarded as the created basis (described below), the inference score of each sample object image 243 is respectively computed by comparing the similarity of the image feature of each calibrated sample object image with the image feature of each corresponding standard object image 253. The inference score indicates a similar level of each sample object image 243 with respect to each corresponding standard object image 253.

In the embodiment, in step S370 the processor 220 computes the average, the standard deviation, or the similar statistical values of all the inference scores to estimate the quality of the object to be inspected. For example, if the average of the inference scores is less than a threshold, it represents that the surface of the overall object to be inspected exists some defects and the quality of the object to be inspected is faulty.

In another embodiment, after computing the rotation bias of the image of object to be inspected 400 (step S320) and before obtaining the plurality of sample object images 243 (step S330), the processor 220 calibrates the image of object to be inspected 400 according to the rotation bias first to generate a calibrated image of object to be inspected and then obtains the plurality of sample object images 243 from the calibrated image of object to be inspected. In the embodiment, the processor 220 performs steps S350, S360, and S370 without step S340. In other words, the processor 220 calibrates the tilt angle of the entire image of object to be inspected 400 by rotating the entire image of object to be inspected 400 and then segments the calibrated image of object to be inspected 400 to obtain the plurality of image blocks.

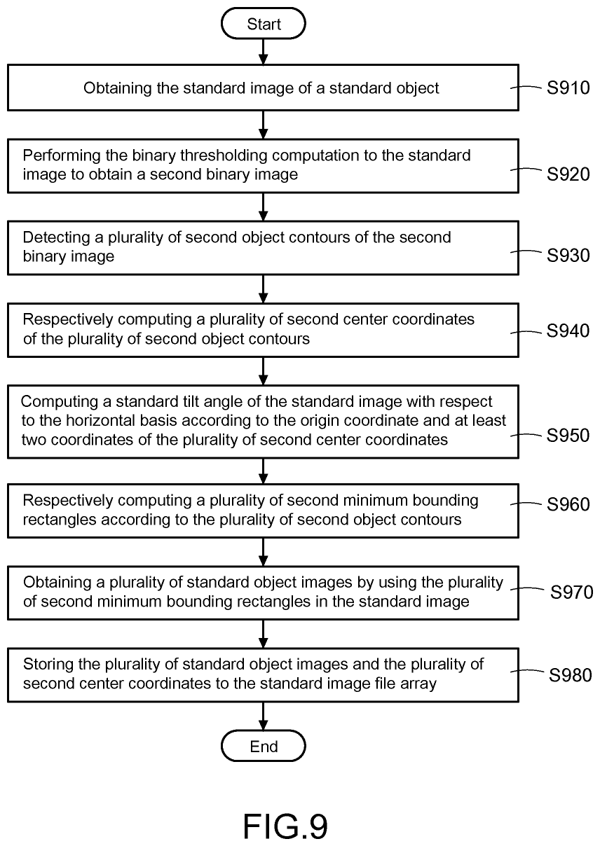

To further describe steps of creating the standard image file array, reference is made to FIG. 9. FIG. 9 is a flowchart of creating the standard image file array according to one embodiment of the present disclosure. Steps of creating the standard image file array 251 may be performed by the image detection device 200 in FIG. 2.

In step S910, the processor 220 obtains the standard image of a standard object.

In step S920, the processor 220 performs the binary thresholding computation to the standard image to obtain a second binary image.

In step S930, the processor 220 detects a plurality of second object contours of the second binary image.

In step S940, the processor 220 respectively computes a plurality of second center coordinates of the plurality of second object contours.

In step S950, the processor 220 computes a standard tilt angle of the standard image with respect to the horizontal basis according to the origin coordinate and at least two coordinates of the plurality of second center coordinates.

In step S960, the processor 220 respectively computes a plurality of second minimum bounding rectangles according to the plurality of second object contours.

In step S970, the processor 220 obtains a plurality of standard object images by using the plurality of second minimum bounding rectangles in the standard image.

In step S980, the processor 220 stores the plurality of standard object images and the plurality of second center coordinates to the standard image file array 251.

In the embodiment, in step S910 the standard object is the physical object that has the same appearance, functions, and model number as the object to be inspected without defects. Accordingly, the standard image is configured to be the basis for comparison.

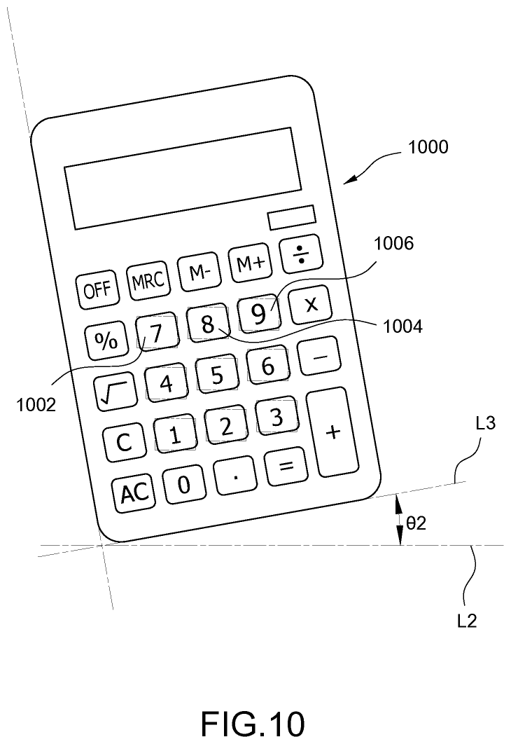

Reference is made to FIG. 10. FIG. 10 is a schematic diagram illustrating the standard image according to one embodiment of the present disclosure. The standard object is not positioned neatly (related to the shooting angle of the image capturing module 210) when being shotted, so the content of the standard image 1000 presents a slight tilt. In the embodiment, the content of the standard image 1000 inclines leftward by a tilt angle (standard tilt angle) with respect to the horizontal basis (line L2) in a counterclockwise direction. In another embodiment, if the standard object is positioned neatly when being shot, the angle between the content of the standard image 1000 and the horizontal basis will be 0 degree.

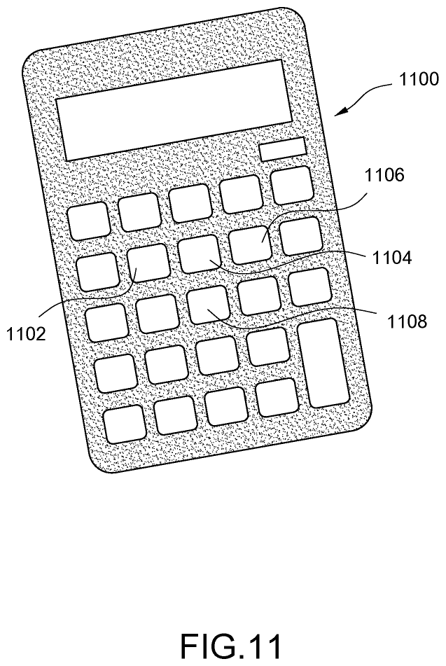

Please refer back to FIG. 9. In the embodiment, in step S920, the processor 220 performs the binary thresholding computation to the standard image 1000. Reference is made to FIG. 11. FIG. 11 is a schematic diagram illustrating the binary image of the standard image according to one embodiment of the present disclosure. The second binary image 1100 may be the monochromatic image.

In the embodiment, because the second binary image 1100 is generated by referring to the image processing, the image features are highly contrasting as shown in FIG. 11, the processor 220 may easily retrieve the button contours (e.g., second object contours 1102, 1104, and 1106 of the white image blocks) based on the image features obtained in step S930.

Please refer back to FIG. 9. In the embodiment, in step S940 the processor 220 detects the object contour 1102 of the second binary image 1100 and computes a second center coordinate of the second object contour 1102. Similarly, the processor 220 detects the second object contours 1104 and 1106 of the second binary image 1100 and respectively computes the second center coordinates of the second object contours 1104 and 1106.

In the embodiment, in step S950 the processor 220 computes the standard tilt angle of the standard image 1000 with respect to the horizontal basis according to the coordinate and the at least two coordinates of the plurality of second center coordinates. For example, the difference value between the y-axis values of the two coordinates is minimal among the coordinates, that is, the two buttons corresponding to the two coordinates are positioned at the same row. As shown in FIG. 11, the difference value between the y-axis value of the center coordinate of the object contour 1102 and that of the object contour 1104 is less than the difference value of the y-axis value of the center coordinate of the object contour 1102 and that of the object contour 1108.

When obtaining the tilt angle, the processor 220 obtains the line representing the tilt level of the standard image 1000 by the center coordinates of the object contour 1102 and the object contour 1104, such as the line parallel to the line L3 (not shown in FIG. 10). Accordingly, the line L3 is configured to represent the tilt level of the standard image 1000.

In one embodiment, the processor 220 computes the angle α between the line L3 and the line L2 (horizontal basis). The processor 220 uses the angle α as the standard tilt angle for calibrating the plurality of sample object images 243 of the image of object to be inspected.

In one embodiment, the origin coordinate may be the image point at the top-left corner of the standard image 1000 or the top-left coordinate of a display screen (not shown in figures) and is regarded as the basis point for estimating the tilt level of the standard image 1000.

In the embodiment, in step S960 the processor 220 obtains the minimum bounding rectangles each enclosing each second object contour of the second binary image 1100 (FIG. 11). Each minimum bounding rectangle is further configured to segment the image blocks corresponding to the object contours of the standard image 1000 to obtain the plurality of standard object images 253.

Reference is made to FIG. 10, the minimum bounding rectangle 1002 encloses the object contour 1102 (FIG. 11); the minimum bounding rectangle 1004 encloses the object contour 1104 (FIG. 11); and the minimum bounding rectangle 1006 encloses the object contour 1106 (FIG. 11).

In the embodiment, in step S970 the processor 220 uses the minimum bounding rectangle 1002 to segment one of the standard object images 253 (such as the image block of the button ‘7’) of the standard image 1000. Similarly, the processor 220 uses the minimum bounding rectangle 1004 to segment one of the standard object images 253 (such as the image block of the button ‘8’) of the standard image 1000; the processor 220 uses the minimum bounding rectangle 1006 to segment one of the standard object images 253 (such as the image block of the button ‘9’) of the standard image 1000.

In the embodiment, in step S980 the processor 220 stores the retrieved standard object images 253 and the plurality of second center coordinates to the standard image file array 251.

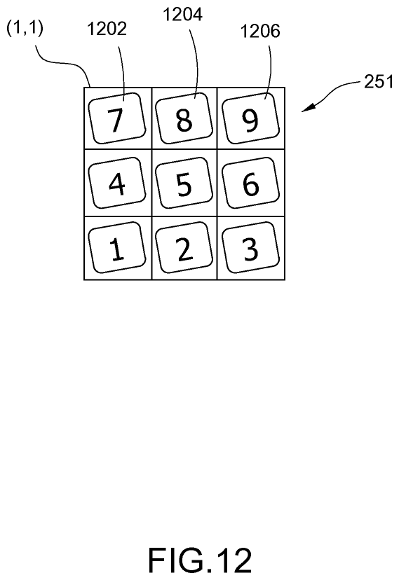

Reference is made to FIG. 12. FIG. 12 illustrates an example standard image file array according to one embodiment of the present disclosure.

Each entry of the standard image file array 251 stores the center coordinates retrieved from the binary image 1100 and the standard object image 253 retrieved from the standard image 1000 (FIG. 10), so the center coordinate may represent the coordinate of the corresponding standard object image 253 stored with the center coordinate. For example, the center coordinate of the object contour 1102 (FIG. 11) and the standard object image 1202 (FIG. 12) are stored in the same entry of the standard image file array 251 to establish the relationship between the center coordinate of the object contour 1102 and the standard object image 1202. Similarly, the entry that stores the standard object image 1204 also contains the corresponding center coordinate, and the entry that stores the standard object image 1206 also contains the corresponding center coordinate.

Because the center coordinates stored in the entry of the same array index of the sample image array 241 and the standard image file array 251 are same or similar (i.e., at the same or similar image position), the entry content of the same array index of the sample image array 241 and the standard image file array 251 corresponds with each other. For example, the entry content (i.e., the sample object image 802) of the array index (1,1) of the sample image array 241 (FIG. 8) represents the button ‘7’; the entry content (i.e., the standard object image 1202) of the array index (1,1) of the standard image file array 250 (FIG. 12) represents also the button ‘7’. Based on the process, the processor 220 maintains the relationship between each entry of the sample image array 241 and the standard image file array 251 based on the center coordinates of the object contours, so the correctness of the inference score of the sample object image 243 computed by the processor 220 is ensured.

Referring to step S360 in FIG. 3 incorporated with FIG. 8 and FIG. 12, the processor 220 compares the image feature of the sample object image 802 stored in the entry of the array index (1,1) of the sample image array 241 with the image feature of the standard object image 1202 stored in the entry of the array index (1,1) of the standard image file array 251 to obtain the inference score of the sample object image 802. By analogy, the processor 220 respectively detects the image feature corresponding to each button to estimate whether the button of the object to be inspected is defective.

In one embodiment, after obtaining the tilt angle θ1 of the image of object to be inspected 400 (step S320), the processor 220 rotates the calibrated image of object to be inspected 400 from the tilt angle θ1 to the standard tilt angle θ2 for calibrating the rotation bias of the entire image of object to be inspected 400, and then retrieves the object contours of the binary image 500, computes the center coordinates, and uses the minimum bounding rectangles to segment the sample object images 243.

In one embodiment, after obtaining the standard tilt angle of the standard image 1000 with respect to the horizontal basis (step S950), the processor 220 rotates the standard image 1000 to calibrate the bias such that the bottom of the calibrated standard image 1000 is consistent with the horizontal basis (i.e., the value of the standard tilt angle θ2 is 0 degree), or respectively rotates the plurality of standard object images 253 to calibrate the bias of each standard object image 253 such that the bottom of each of the standard object images is consistent with the horizontal basis. In the embodiment, in step S340 when respectively calibrating the bias of the sample object image 243, the processor 220 has to set the horizontal basis as the rotation bias (i.e., the value of the standard tilt angle θ2 is 0 degree) to maintain the same rotation bias between the sample object image 243 and the standard object image 253, to enhance the correctness of comparing the image blocks.

Accordingly, the image detection device and the image detection method of the present disclosure estimate the quality of the object to be inspected by merely comparing the image features of the image blocks, so the problem of comparing the entire image to obtain the detection result is solved. The present disclosure also reduces the misjudgment by calibrating the tilt angle of the sample object image when comparing the image features of the image blocks; therefore, the efficiency of image detection is enhanced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image detection device, comprising:
an image capturing module configured to obtain an image of object to be inspected from an object to be inspected;
a storage medium configured to store a standard image file array, wherein the standard image file array comprises a plurality of standard object images; and
a processor connected to the image capturing module and the storage medium and configured to:
obtain a plurality of sample object images from the image of object to be inspected;
store the plurality of sample object images in a sample image array, wherein the sample image array and the standard image file array comprise same array index;
respectively compare the plurality of sample object images of the sample image array and the plurality of standard object images of the standard image file array based on the array index to compute an inference score of each of the plurality of sample object images; and
estimate a quality of the object to be inspected according to the inference score of the plurality of sample object images.

2. The image detection device of claim 1, wherein the storage medium is configured to store a standard tilt angle; before obtaining the plurality of sample object images of the image of object to be inspected, the processor is configured to:
compute a tilt angle of the image of object to be inspected; and
compute a rotation bias of the image of object to be inspected according to a difference value between the tilt angle and the standard tilt angle.

3. The image detection device of claim 2, wherein before storing the plurality of sample object images to the sample image array, the processor is configured to:
respectively calibrate a bias of the plurality of sample object images according to the rotation bias; and
store the plurality of sample object images calibrated to the sample image array.

4. The image detection device of claim 2, wherein after computing the rotation bias of the image of object to be inspected, the processor is configured to:
calibrate a bias of the image of object to be inspected according to the rotation bias; and
obtain the plurality of sample object images in the image of object to be inspected calibrated.

5. The image detection device of claim 3, wherein operation of the processor to compute the inference score of each of the plurality of sample object images comprises:
respectively comparing the plurality of sample object images calibrated of the sample image array with the plurality of standard object images of the standard image file array according to the array index to compute the inference score of each of the plurality of sample object images.

6. The image detection device of claim 2, wherein operation of the processor to compute the tilt angle of the image of object to be inspected comprises:
performing a binary thresholding computation to the image of object to be inspected to obtain a first binary image;
detecting a plurality of first object contours of the first binary image and respectively computing a plurality of first center coordinates of the plurality of first object contours; and
computing the tilt angle of the image of object to be inspected with respect to a horizontal basis according to at least two coordinates of the plurality of first center coordinates and an origin coordinate.

7. The image detection device of claim 6, wherein the operation is configured to obtain the plurality of sample object images of the image of object to be inspected by using a plurality of first minimum bounding rectangles, and the operation of obtaining the plurality of sample object images of the image of object to be inspected comprises:
respectively computing the plurality of first minimum bounding rectangles according to the plurality of first object contours; and
obtaining the plurality of sample object images of the image of object to be inspected by using the plurality of first minimum bounding rectangles.

8. The image detection device of claim 1, wherein before the storage medium stores the standard image file array, the processor is configured to:
perform a binary thresholding computation to a standard image to obtain a second binary image, wherein the standard image comprises a standard tilt angle;
detect a plurality of second object contours of the second binary image;
respectively compute a plurality of second minimum bounding rectangles according to the plurality of second object contours; and
respectively use the plurality of second minimum bounding rectangles to obtain the plurality of standard object images of the standard image.

9. The image detection device of claim 8, wherein after detecting the plurality of second object contours of the second binary image, the processor is configured to:
respectively compute a plurality of second center coordinates of the plurality of second object contours; and
compute the standard tilt angle of the standard image with respect to a horizontal basis according to at least two of the plurality of second center coordinates and an origin coordinate.

10. An image detection method for an object to be inspected, comprising:
obtaining an image of object to be inspected from an object to be inspected;
obtaining a plurality of sample object images from the image of object to be inspected;
storing the plurality of sample object images to a sample image array, wherein the sample image array and a standard image file array comprise same array index and the standard image file array comprises a plurality of standard object images;
respectively comparing the plurality of sample object images of the sample image array with the plurality of standard object images of the standard image file array to compute an inference score of each of the plurality of sample object images; and
estimating a quality of the object to be inspected according to the inference score of the plurality of sample object images.

11. The image detection method of claim 10, before obtaining the plurality of sample object images of image of object to be inspected, further comprising:
computing a tilt angle of the image of object to be inspected; and
computing a rotation bias of the image of object to be inspected according to a difference value between the tilt angle and a standard tilt angle.

12. The image detection method of claim 11, before storing the plurality of sample object images to the sample image array, further comprising:
respectively calibrating a bias of the plurality of sample object images according to the rotation bias; and
storing the plurality of sample object images calibrated to the sample image array.

13. The image detection method of claim 11, after computing the rotation bias of the image of object to be inspected, further comprising:
calibrating the image of object to be inspected by the rotation bias; and
obtaining the plurality of sample object images from the image of object to be inspected calibrated.

14. The image detection method of claim 13, wherein step of computing the inference score of each of the plurality of sample object images comprises:
respectively comparing the plurality of sample object images of the sample image array with the plurality of standard object images of the standard image file array according to the array index to compute the inference score of each of the plurality of sample object images.

15. The image detection method of claim 11, wherein step of computing the tilt angle of the image of object to be inspected further comprises:
performing a binary thresholding computation to the image of object to be inspected to obtain a first binary image;
detecting a plurality of first object contours of the first binary image and respective computing a plurality of first center coordinates of the plurality of first object contours; and
computing the tilt angle of the image of object to be inspected with respect to a horizontal basis according to at least two coordinates of the plurality of first center coordinates and an origin coordinate.

16. The image detection method of claim 15, before step of obtaining the plurality of sample object images of the image of object to be inspected, further comprising:
respectively computing a plurality of first minimum bounding rectangles according to the plurality of first object contours;
wherein step of obtaining the plurality of sample object images of the image of object to be inspected comprises obtaining the plurality of sample object images of the image of object to be inspected by using the plurality of first minimum bounding rectangles.

17. The image detection method of claim 10, further comprising:
performing a binary thresholding computation to a standard image to obtain a second binary image;
detecting a plurality of second object contours of the second binary image;
respectively computing a plurality of second minimum bounding rectangles according to the plurality of second object contours; and
respectively using the plurality of second minimum bounding rectangles to obtain the plurality of standard object images of the standard image.

18. The image detection method of claim 17, further comprising:
respectively computing a plurality of second center coordinates of the plurality of second object contours; and
computing the standard tilt angle of the standard image with respect to a horizontal basis according to at least two coordinates of the plurality of second center coordinates and an origin coordinate.
